(19) United States
(12) Patent Application Publication
(10) Pub. No.: US 2011/0225170 A1
(43) Pub. Date: Sep. 15, 2011

(54) ADAPTABLE RELEVANCE TECHNIQUES FOR SOCIAL ACTIVITY STREAMS

(75) Inventors: Oludare Obasanjo, Renton, WA (US); Alexander S. Ford, Carnation, WA (US); Seung-Hae Park, Seattle, WA (US)

(73) Assignee: MICROSOFT CORPORATION, Redmond, WA (US)

(21) Appl. No.: 12/721,589

(22) Filed: Mar. 11, 2010

(51) Int. Cl. G06F 15/16; G06F 17/30

(52) U.S. Cl. 707/748; 709/203; 707/E17.014

(57) ABSTRACT

A social networking activity reporting system (“SNARS”) and techniques are used for notifying a user of a client-side electronic device about updates (“activity items,” or “AIs”) from the user's social network. A relevance formula, which includes at least one time-dependent portion and at least one time-independent portion, is used to calculate a relevance score for an AI. For each AI, the time-dependent portion includes at least one factor based on a dynamic relationship between the user and the AI (for example, the relationship between the user or others in the user's social network and the publisher; or the amount of interaction the user or others in the user's social network have had with the item or subject). The AIs are presented in ascending or descending order based on the relevance scores. The relevance formula may be updated and re-applied to the same or a different set of activity items.

### BACKGROUND

Network-based communities are comprised of people who share a common interest or affiliation. Network-based communities (and their members) with which a person is affiliated are referred to as the person's “social network.”

Community members often share content via computing resources (generally, server- or service-based resources), which are referred to as “social networking resources.” Social networking resources are generally identified and/or accessed by uniform resource identifiers (“URIs”). The audio, video, image, text, data, and/or multimedia content that is legally made available via social networking resources is referred to as social networking content. Examples of personal and commercial social networking resources include but are not limited to: applications such as email, games, and the like; blogs; discussion forums; and websites or web pages. Examples of commercial websites include but are not limited to Facebook.com, Twitter.com, Linkedin.com, Flixster.com, Myspace.com, Tagged.com, Classmates.com, and the like.

Often a person using a particular client-side electronic device (for example, a personal computer, a mobile phone, a gaming device, a personal digital assistant, a media player, or a navigation device) would like to be notified when new social networking content is published via social networking resources within his or her social network. The person may also desire to reduce the chore of looking through new and/or older content in chronological order and/or on a resource-by-resource basis to find the content of most interest to him or her.

### SUMMARY

A social networking activity reporting system (“SNARS”), aspects of which may be implemented in a network-based or a client-based operating environment, notifies a user of a client-side electronic device about certain social networking content (referred to as one or more “activity items”) published within the user's social network. Each activity item has a publisher and a publishing time.

From time to time, the SNARS uses a relevance formula, which is based on a number of metrics, to calculate a relevance score for each activity item in a predetermined set of activity items. The relevance score is a measure of interestingness of the activity item to the user.

The metrics of the relevance formula include at least one time-dependent portion and at least one time-independent portion, both of which include one or more factors. The portions and/or factors thereof may be weighted. Various time-independent and time-dependent factors and factor selection criteria are possible and are discussed herein. Exemplary factors of the time-independent portion include but are not limited to the subject of the activity item and the publisher of the activity item.

The time-dependent portion includes at least one factor based on a dynamic relationship between the user and the particular activity item. Examples of a dynamic relationship include but are not limited to: the relationship between the user (or others in the user's social network) and the publisher of the activity item; an explicit or inferred interest of the user in the subject; and the amount of interaction the user or others in the user's social network have had with the activity item or the subject of the activity item. The time-dependent portion also generally includes at least one factor based on the publishing time of the activity item. In one exemplary scenario, factors based on the dynamic relationship between the user and the activity item are weighted such that they have more influence over the relevance score than other factors.

The activity items are presented to the user via the client-side electronic device in an ascending or descending order based on the relevance scores.

From time-to-time the relevance formula and/or factors or weightings thereof may be updated automatically or manually and received by the client-side electronic device, and the updated relevance formula may be used to calculate new relevance scores for the same or a different set of activity items. Updated relevance formulas may be requested by client-based applications either as executable code or as a set of inputs to a function when retrieving new activity items.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this document.

### BRIEF DESCRIPTION OF THE DRAWINGS

FIG. 1 is a simplified functional block diagram illustrating an exemplary communication architecture within which aspects of a social networking activity reporting system (“SNARS”) may be implemented or used.

FIG. 2 is a flowchart of an exemplary method for using aspects of the SNARS shown in FIG. 1.

FIG. 3 is a simplified functional block diagram of an exemplary operating environment in which aspects of the SNARS shown in FIG. 1 and/or the method(s) shown in FIG. 2 may be implemented or used.

### DETAILED DESCRIPTION

The social networking activity reporting system (“SNARS”) and techniques described herein operate in client- and/or network-based devices to notify a user of a client-side electronic device about new social networking content (“activity items”) published within the user's social network. Exemplary operation of the SNARS is described with reference to certain factors of a relevance formula used to calculate a relevance score for each activity item in a particular set of activity items. The relevance score is a measure of interestingness of the activity item to the user. More specifically, the relevance score is determined based on one or more dynamic relationships between the user and a particular activity item. It will be appreciated, however, that there are many other time-independent and time-dependent factors and factor selection criteria that may be used to calculate the relevance score, and with which the system and techniques described herein may be implemented or used.

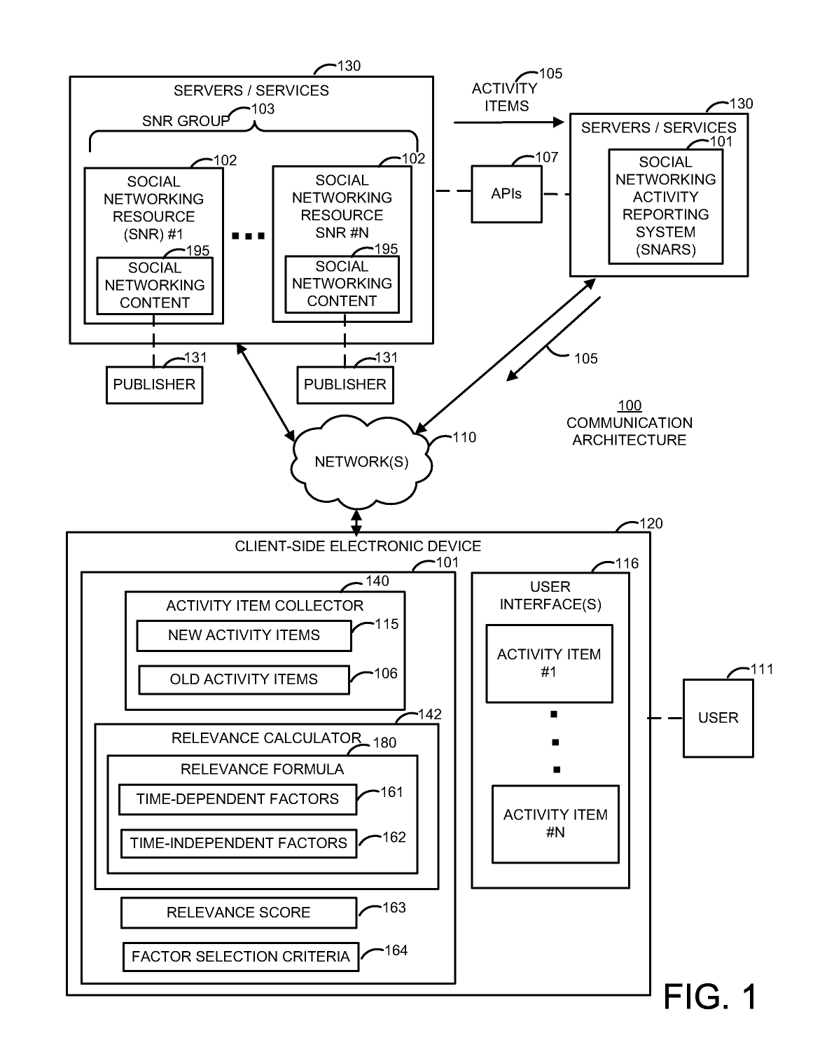

Turning now to the drawings, where like numerals designate like components, FIG. 1 is a simplified functional block diagram illustrating an exemplary communication architecture 100 within which aspects of a network- and/or client-based SNARS 101 are implemented or used. In general, design choices and/or operating environments dictate how and where specific functions of SNARS 101 are implemented (for example, it will be appreciated that operations that involve use of aggregate data are generally performed on a server). Such functions may be implemented using hardware, software, firmware, or combinations thereof. As shown, network-based SNARS 101 is implemented as a server/service 130 within network(s) 110, which represent any existing or future, public or private, wired or wireless, wide-area or local-area, packet-switched or circuit-switched communication infrastructures or technologies. Client-based SNARS 101 is implemented within client-side electronic device 120. Examples of client-side electronic devices 120 include but are not limited to personal computers, home entertainment devices such as set-top boxes, mobile phones, gaming devices, personal digital assistants, media players, navigation devices or any known or later-developed combination thereof.

SNARS 101 is responsible for identifying, retrieving, aggregating, ordering and presenting (via user interface(s) 116) activity items 105 to a user 111 of a client-side electronic device 120. As shown, SNARS 101 includes: an activity item collector 140; and a relevance calculator 142.

Activity items 105 represent items of social networking content 195 that are legally published from time-to-time via a particular group 103 of two or more social networking resources (“SNRs”) 102. Each item of social networking content 195 (and thus activity item 105) has a publisher 131 and a subject (not shown).

SNRs 102 represent any known or later-developed computing resources that are accessible by people who share a common interest or affiliation, such as people drawn together by family, work, or hobbies. Social networking resources are generally identified, directly or indirectly, by uniform resource identifiers (“URIs”), such as addresses of files or pages on the World Wide Web (“WWW”; pages on the WWW are also referred to as “web pages” or “websites”). It will be appreciated, however, that social networking resource may be identified by any known or later developed construct or technique. SNRs 102 are accessed via network(s) 110 by user 111 via client-side electronic device 120, which is configured for communication with network(s) 110. Examples of social networking resources include but are not limited to: personal blogs, websites, or files; and commercial websites such as Facebook.com, Twitter.com, Linkedin.com, Flixster.com, Myspace.com, Tagged.com, Classmates.com, and others.

Social networking content 195 represents audio, video, image, text, data, and/or multimedia content that is legally published and/or distributed via a particular social networking resource, for personal consumption by users of client-side electronic devices that access the particular social networking resource. Social networking content 195 may exist in any known or later developed format or combination thereof. Social networking content may be protected by one or more enforceable intellectual property rights (such as copyrights, patent rights, trademark rights, or trade secret rights) of the publisher/distributor or one or more third parties. A recipient such as user 111 may be, but is not necessarily, required to be authorized to access a particular social networking resource 102 or item of social networking content 195.

Publishers 131 represent the distributors or authors of social networking content 195. For example, publishers 131 may be entities authorized to control social networking resources 102, via which activity items 105 that user 111 may be interested in learning about are published, or publishers 131 may be the creators and/or original sources, or re-distributors, of social networking content 195. User 111 may be referred to as having a “social network” (not shown), which is a group of publishers 131 and/or social networking resources 102. A user's social network may be dynamic, changing over time as user's contact with social networking resources 102 is increased, decreased, or otherwise modified.

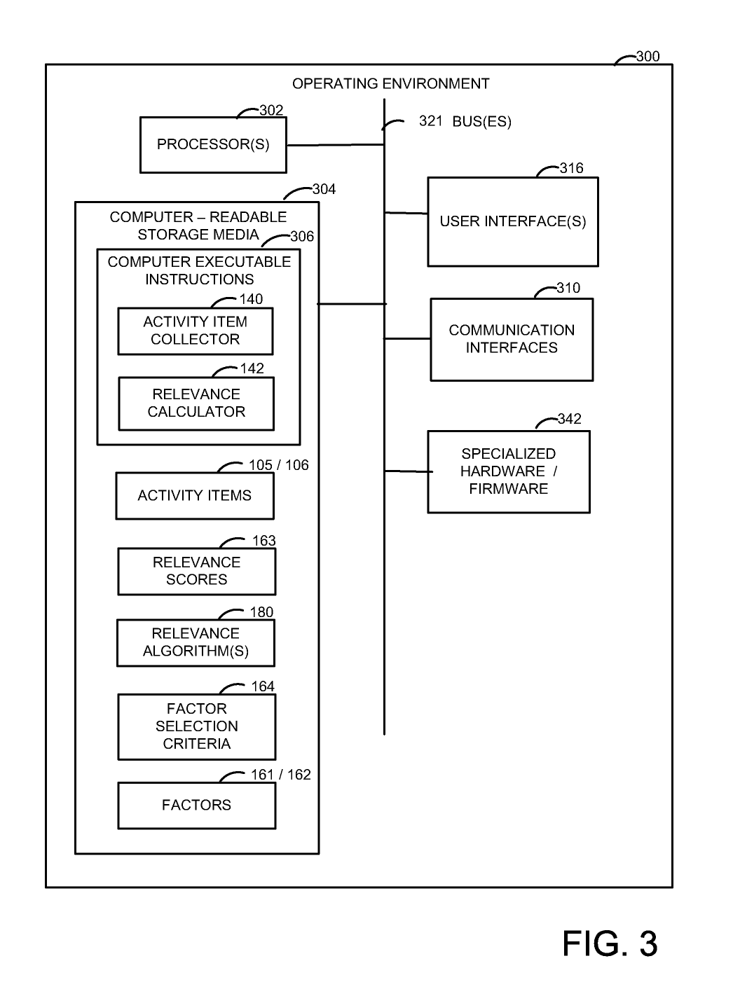

Turning again to the discussion of the functions of SNARS 101 shown in FIG. 1, activity item collector 140 is responsible for retrieving/receiving activity items 105 from group 103 of SNRs 102. In some scenarios it is useful to refer to activity items 105 as being “new” activity items 115, or “old” activity items 106. New activity items 115 are those activity items that have not been previously presented to user 111. Old activity items 106 are those activity items that have been previously presented to the user and/or stored in a computer-readable storage medium (such as a computer-readable storage medium 304, discussed further in connection with FIG. 3).

One exemplary technique for retrieving/receiving activity items 105 from social networking resources 102 involves a network- or client-based implementation of SNARS 101 retrieving information on a resource-by-resource basis, via application programming interfaces 107, which facilitate programmatic communication with specific social networking resources (as shown, application programming interfaces 107 are usable by network-based implementation of SNARS 101). Really simple syndication (“RSS”) is a family of web feed formats commonly used to publish and accept subscriptions to frequently updated social networking resources and/or social networking content. Any known or later developed service, protocol or technique, however, may be used retrieve or receive activity items 105.

Relevance calculator 142 is responsible for using a relevance formula 180 to calculate a relevance score 163 for each activity item 105 in a predetermined set of activity items. Relevance formula 180 includes at least two portions—a time-dependent portion 161 and a time-independent portion 162—each of which is a metric that may be based on a number of factors. The relevance score is a measure of interestingness of the activity item to the user. Activity items in the set are presented to user 111 via user interface(s) 116 associated with client-side electronic device 120 in an ascending or descending order based on the relevance scores.

Various time-independent and time-dependent factors are possible. The factors (individually or in groups) may be weighted to arrive at the relevance scores. Exemplary relevance factors include but are not limited to: the content type of the activity item (e.g., text, multimedia, game-related, etc.); the relationship of the publisher of the activity item to the user; the amount of interaction people have had with the activity item (e.g., comments, views, ratings, etc.); and the age of the activity item. In an exemplary relevance formula, a relevance score of the activity item would be calculated by summing sub-scores based on each relevance factor. Activity items that end up with the same score may be further sorted chronologically. In one exemplary implementation, each relevance factor adds up to three (3) points to the relevance score of an activity item. For example, a content type factor may increase the score of an activity item by one (1) if it is a “low” value activity item, and as much as three (3) if it is a “high” value activity item. Similarly, based on whether the publisher is a close friend, acquaintance, or in another personal relationship to the user, up to three points may be added to the relevance score of the activity item. With respect to the amount of interaction (comments, for example), certain numbers of comments may be associated with certain numbers of additional points being added to the relevance score of the activity item—in one possible scenario, one comment equals one point, between two and four comments equals two points, and five or more comments equals three points. Points may be deducted from the relevance score as the age of the activity item increases—in one possible scenario, activity items lose one point per day.

Factor selection criteria 164 may be useful in establishing relevance formula 180. Factor selection criteria 164 represent any information usable by SNARS 101 or user 111 for decision-making regarding interestingness of activity items 105. As such, factor selection criteria 164 may be received from user 111, or received in other ways, such as by being programmed into SNARS 101, obtained by SNARS 101 using heuristics, or received from a third party (for example, a local or remote service). Examples of factor selection criteria 164 include but are not limited to: information about user 111 (such as user profiles, user preferences, user identities, information collected based on previous activities of the user with respect to SNARS 101 or other services, and electronic affiliations of user 111 with other people or services as determined by user communities, buddy lists or service subscriptions); temporal references (such as times, dates, or time zone data); and information related to activity items (such as data item type/format, subject, publisher, parental control ratings, presentation formats or quality, price/promotions, genre, source, titles, artists, and the like.) To address privacy concerns, user 111 may have control over whether and/or which information about user 111 is collected and used by SNARS 101.

With respect to the time-dependent portion of relevance formula 180, at least one factor is based on a dynamic relationship between user 111 and the particular activity item 105. Examples of such dynamic relationships include but are not limited to: the relationship between the user (or others in the user's social network) and the publisher of the activity item; an explicit or inferred interest of the user in the subject; and the amount of interaction the user or others in the user's social network have had with the activity item or the subject of the activity item. The time-dependent portion also generally includes at least one factor based on the publishing time of the activity item.

In one exemplary scenario, the dynamic relationship factor is weighted such that it has more influence over the relevance score than other factors of the relevance formula. In an exemplary scenario that illustrates the effect of such increased weighting, consider the following: user 111 communicates frequently with a publisher or subject of a particular activity item 105, or places the publisher or subject in a particular explicit relationship with him/herself (e.g., “family”); this dynamic relationship is weighted such that it is more influential on the relevance score 163 of the activity item than, for example, the statically-defined subject of the activity item.

From time-to-time relevance formula 180 and/or factors or weightings thereof may be updated automatically or manually, and the updated relevance formula may be used to calculate new relevance scores 163 for the same or a different set of activity items, which may be re-presented to the user in the new relevance order. The sets of activity items may include new activity items 115, old activity items 106, or combinations thereof. Updated relevance formulas may be requested by client-based applications either as executable code or as data to a function when retrieving activity items 105.

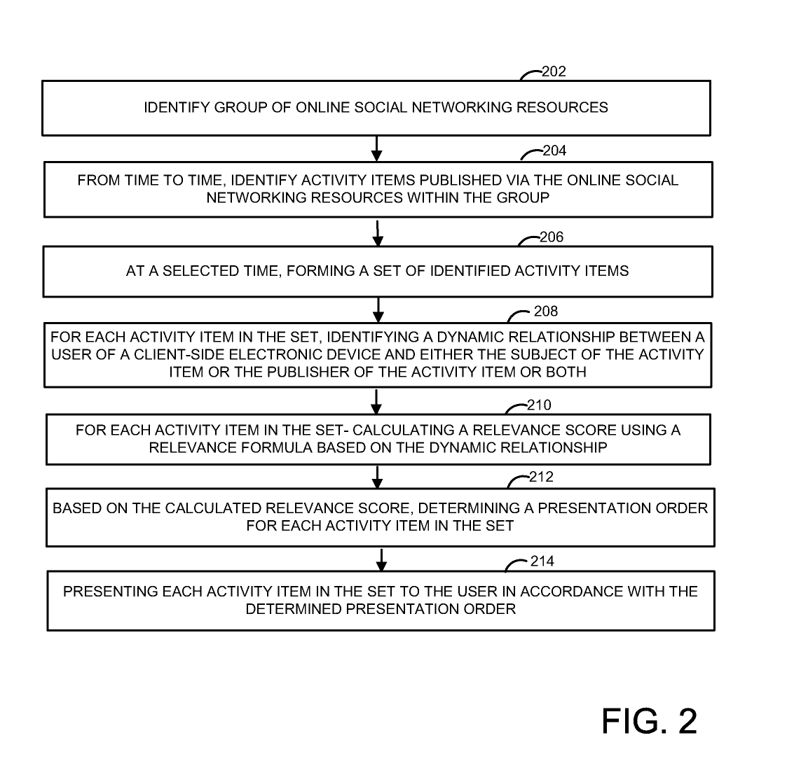

With continuing reference to FIG. 1, FIG. 2 is a flowchart illustrating an exemplary method for using aspects of SNARS 101 to present certain activity items to a particular user of a client-side electronic device (such as certain activity items 105 published via a particular group 103 of social networking resources 102 within the social network of a particular user, such as user 111, of client-side electronic 120) in an order related to a notion of relevance, or interestingness, to the particular user. Specifically, a relevance formula, such as relevance formula 180, is identified and evaluated to calculate a relevance score, such as relevance score 163, for each activity item. The relevance score is used to determine the order of presentation of the activity item to the user.

The method illustrated in FIG. 2 may be implemented by computer-executable instructions (such as computer-executable instructions 306, shown and discussed in connection with FIG. 3) that are stored in a computer-readable storage medium (computer-readable storage media 304 are also shown and discussed in connection with FIG. 3) and executed by one or more general, multi-purpose, or single-purpose processors (such as processor 302, also shown and discussed in connection with FIG. 3). Unless specifically stated, the methods or steps thereof are not constrained to a particular order or sequence. In addition, some of the methods or steps thereof can occur or be performed concurrently.

The method begins at block 202, where a group of online social networking resources, such as group 103 of social networking resources 102, is identified. The group of social networking resources may be all or a portion of the social network (not shown) of user 111 of CED 120.

Next, at block 204, activity items that are published from time-to-time via at least some of the social networking resources within the group of block 202 are identified. In an exemplary scenario, network- or client-based SNARS 101 uses one or more APIs 107 to identify and retrieve (in a push or pull manner) activity items 105 that have been published in a certain timeframe from server(s)/service(s) 130. A client-side electronic device may store the set of retrieved activity items. Generally, an entity (the activity item publisher or another entity) responsible for controlling social networking resources provides APIs 107 and/or network- or client-based interfaces (not shown), which facilitate retrieval of activity items and provide information about such activity items in the form of metadata. Exemplary information includes but is not limited to information about publishers and times of publication.

At block 206, at a selected time, a set of activity items is formed. The set includes activity items having different publishers, which were published via different online social networking resources. The selected time may be periodic (for example, a set of activity items may be formed automatically at regular intervals, such as a certain number of minutes, hours, or days), or may occur at irregular time intervals, such as upon user request or the accumulation of a certain number of new activity items. The set of activity items may include new activity items 115), old activity items 106, or any combination thereof.

As indicated at block 208, for each activity item in the set formed at block 206, a dynamic relationship between the user of the client-side electronic device and either the subject of the activity item or the publisher activity item or both is identified. Generally, the dynamic relationship is one of a possible number of factors (which may be individually or collectively weighted) that form a time-dependent metric of a selected relevance formula. Another example of a time-dependent factor is the publishing time of the activity item. As discussed above, it will be appreciated that there are many possible time-independent and time-dependent factors, as well as factor selection criteria and sources thereof, which may be used/combined to define relevance formula 180. Relevance formula 180 may also be modified or replaced from time-to-time, such as when new relevance factors are determined, or the weights of various factors are adjusted based on heuristics or user feedback.

Examples of the dynamic relationship include but are not limited to: the relationship between the user (or others in the user's social network) and the publisher of the activity item; an explicit or inferred interest of the user in the subject; and the amount of interaction the user (or others in the user's social network) have had with the activity item or the subject of the activity item. In one possible implementation, factors based on the dynamic relationship are weighted such that they have more influence on the time-dependent metric. For example, encoding the fact that a user communicates frequently with a publisher of an activity item or a subject of an activity item, or a publisher or subject that has a relatively high status (such as “family” status) in the context of certain social networking resources, may result in the dynamic relationship factor of activity items having that publisher or subject receiving a relatively larger weight than other factors of a selected relevance formula.

Using the relevance formula 180, as indicated at block 210, a relevance score 163 is calculated for each activity item in the set. In the case where a client-based SNARS 101 receives (for example, requests) activity items 105 from server(s)/service(s) 130, in one possible implementation the current relevance formula 180 is also retrieved (from a server-based SNARS 101, for example), and inputs to the relevance formula 180 for each activity item are generated. If the relevance formula has changed since the client last received or ordered activity items, the relevance scores of older activity items may be re-determined using the current relevance formula, either separately or relative to the newly-retrieved activity items.

At block 212, based on the calculated relevance scores, a presentation order for each activity item in the set is determined. Activity items may be presented in order of ascending or descending relevance scores. Finally, as indicated at block 214, the activity items are presented to the user in accordance with the presentation order determined at block 212.

With continuing reference to FIGS. 1 and 2, FIG. 3 is a simplified functional block diagram of an exemplary operating environment 300, with which aspects of SNARS 101 may be implemented or used. Operating environment 300 is indicative of a wide variety of general-purpose, special-purpose, client- or server-based, stand-alone or networked computing environments. Operating environment 300 may be, for example, a type of computer, such as a workstation, a server, a client-side electronic device, or any other type of stand-alone or networked computing device or component thereof now known or later developed. Operating environment 300 may also be a distributed computing network or Internet-based service, for example.

One or more components shown in FIG. 3 may be packaged together or separately to implement functions of operating environment 300 (in whole or in part) in a variety of ways. As shown, bus(es) 321 carries data, addresses, control signals and other information within, to, or from computing environment 300 or components thereof.

Communication interface(s) 310 are one or more physical or logical elements that enhance the ability of operating environment 300 to receive information from, or transmit information to, another operating environment (not shown) via a communication medium. Examples of communication media include but are not limited to: wireless or wired signals; computer-readable storage media; computer-executable instructions; communication hardware or firmware; and communication protocols or techniques.

Specialized hardware/firmware 342 represents any hardware or firmware that implements functions of operating environment 300. Examples of specialized hardware/firmware 342 include encoder/decoders (“CODECs”), decrypters, application-specific integrated circuits, secure clocks, and the like.

A processor 302, which may be one or more real or virtual processors, controls functions of operating environment 300 by executing computer-executable instructions 306 (discussed further below).

Computer-readable storage media 304 represent any number and combination of local or remote components, in any form, now known or later developed, capable of recording or storing computer-readable data, such as instructions 306 (discussed further below) executable by processor 302, and including but not limited to activity items 105 and 106, relevance scores 160, relevance algorithms 180, factor selection criteria 164, and factors 161/162. In particular, computer-readable media 304 may be, or may include persistent memory or main memory, and may be in the form of: a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; or any combination thereof.

Computer-executable instructions 306 represent any signal processing methods or stored instructions that electronically control predetermined operations on data. In general, computer-executable instructions 306 are implemented as software programs according to well-known practices for component-based software development, and encoded in computer-readable media (such as one or more types of computer-readable storage media 304). Software programs may be combined or distributed in various ways. Among other things, functional aspects of activity item collector 140 and relevance calculator 142 are implemented using computer-executable instructions.

User interface(s) 316 represent a combination of presentation tools and controls that define the way a user, such as a user of a client-side electronic device, interacts with operating environment 300. One type of user interface 316 is a graphical user interface (“GUI”), although any known or later developed type of user interface is possible. Presentation tools are used to receive input from, or provide output to, a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function as an interface for both inputs to, and outputs from, a user.

Various aspects of an operating environment and an architecture/techniques that are used to implement aspects of SNARS 101 have been described. It will be understood, however, that all of the described elements need not be used, nor must the elements, when used, be present concurrently. Elements described as being computer programs are not limited to implementation by any specific embodiments of computer programs, and rather are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable storage medium encoded with computer-executable instructions which, when executed by a processor associated with a client-side electronic device, perform a method comprising:
identifying a group of online social networking resources;
from time to time, identifying activity items comprising items of social networking content that have been published via online social networking resources within the group of online social networking resources, each activity item having a publisher and a subject, and having been published at a publishing time;
at a selected time, forming a set of identified activity items, the set including activity items having different publishers and published via different online social networking resources;
for each activity item in the set, identifying a dynamic relationship between a user of the client-side electronic device and either the subject of the activity item or the publisher of the activity item or both;
for each activity item in the set, calculating a relevance score using a relevance formula based on the dynamic relationship;
based on the calculated relevance score, determining a presentation order for each activity item in the set; and
via the client-side electronic device, presenting each activity item in the set to the user in accordance with the determined presentation order.

2. The computer-readable storage medium according to claim 1, wherein the method further comprises:
storing the set;
at a time after the selected time, identifying an updated relevance formula, different from the relevance formula; and
for each activity item in the stored set, calculating a new relevance score using the new relevance formula;
based on the calculated new relevance scores, determining a new presentation order for each activity item in the stored set; and
presenting each activity item in the stored set to the user of the client-side electronic device in accordance with the determined new presentation order.

3. The computer-readable storage medium according to claim 1, wherein the method further comprises:
at a subsequent time after the selected time, identifying at least one new activity item comprising an item of social networking content that was published via an online social networking resource within the group of online social networking resources, the new activity item having a publisher and a subject, and having been published at a publishing time after the publishing times of each of the activity items of the set;
forming a new set of activity items, the new set including the set of identified activity items and the new activity item;
for each activity item in the new set, identifying the dynamic relationship between the user of the client-side electronic device and either the subject of the activity item or the publisher of the activity item or both;
for each activity item in the new set, calculating a relevance score using the relevance formula;
based on the calculated relevance scores, determining a new presentation order for each activity item in the new set; and
presenting each activity item in the new set to the user of the client-side electronic device in accordance with the new presentation order.

4. The computer-readable storage medium according to claim 1,
wherein the relevance formula includes at least one time-dependent portion and at least one time-independent portion, the dynamic relationship a factor associated with the time-dependent portion.

5. The computer-readable storage medium according to claim 4, wherein the method further comprises:
assigning a first weight to the at least one time-independent portion; and
assigning a second weight to the at least one time-dependent portion,
the relevance scores calculated based on the assigned first and second weights.

6. The computer-readable storage medium according to claim 1, wherein for each activity item, the dynamic relationship is selected from the group comprising: an online relationship between the publisher and the user; an explicit or inferred interest of the user in the subject; and an amount of online interaction other people in the user's social network have had with the activity item or subject.

7. The computer-readable storage medium according to claim 1, wherein the plurality of online publishers comprise members of the user's social network.

8. The computer-readable storage medium according to claim 1, wherein the presentation order is selected from the group comprising: ascending relevance order; and descending relevance order.

9. The computer-readable storage medium according to claim 1, wherein identifying activity items comprises receiving activity items from an online server, and wherein the relevance formula is received from the online server.

10. A computer-readable storage medium encoded with computer-executable instructions which, when executed by a processor associated with an online server, perform a method comprising:
identifying a group of online social networking resources;
from time to time, identifying activity items comprising items of social networking content that have been published via online social networking resources within the group of online social networking resources, each activity item having a publisher and a subject, and having been published at a publishing time;
at a selected time, forming a set of identified activity items, the set including activity items having different publishers and published via different online social networking resources;
for each activity item in the set, identifying a dynamic relationship between a user of a client-side electronic device and either the subject of the activity item or the publisher of the activity item or both; and
for each activity item in the set, calculating a relevance score using a relevance formula based on the dynamic relationship.

11. The computer-readable storage medium according to claim 10,
wherein identifying the plurality of online publishers comprises identifying one or more social networking resources associated with each of the plurality of online publishers, and
wherein identifying the set of activity items comprises accessing the one or more social networking resources, and retrieving individual activity items comprising the set.

12. The computer-readable storage medium according to claim 10, wherein the method further comprises:
transmitting the relevance formula to the client-side electronic device; and
transmitting the set to the client-side electronic device.

13. The computer-readable storage medium according to claim 10, wherein the method further comprises:
at a subsequent time after the selected time, identifying at least one new activity item comprising an item of social networking content that was published via an online social networking resource within the group of online social networking resources, the new activity item having a publisher and a subject, and having been published at a publishing time after the publishing times of each of the activity items of the set;
forming a new set of activity items, the new set including the set of identified activity items and the new activity item;
for each activity item in the new set, identifying the dynamic relationship between a user of the client-side electronic device and either the subject of the activity item or the publisher of the activity item or both;
for each activity item in the new set, calculating a relevance score using the relevance formula; and
based on the calculated relevance scores, determining a new presentation order for each activity item in the new set.

14. The computer-readable storage medium according to claim 10,
wherein the relevance formula includes at least one time-dependent portion and at least one time-independent portion, the dynamic relationship a factor associated with the time-dependent portion.

15. The computer-readable storage medium according to claim 14, wherein the method further comprises:
assigning a first weight to the at least one time-independent portion; and
assigning a second weight to the at least one time-dependent portion,
the relevance scores calculated based on the assigned first and second weights.

16. The computer-readable storage medium according to claim 12, wherein the dynamic relationship is selected from the group comprising: an online relationship between the publisher and the user; an explicit or inferred interest of the user in the subject; and an amount of online interaction other people in the user's social network have had with the activity item or subject.

17. A system for reporting social networking activity to a user of a client-side electronic device, the system comprising:
a computer-readable storage medium; and
a processor responsive to the computer-readable storage medium and to one or more computer programs stored in the computer-readable storage medium, the one or more computer programs, when loaded into the processor, operable to perform a method comprising:
identifying a group of online social networking resources,
from time to time, receiving from an online server activity items comprising items of social networking content that have been published via online social networking resources within the group of online social networking resources, each activity item having a publisher and a subject, and having been published at a publishing time,
at a selected time, forming a set of identified activity items, the set including activity items having different publishers and published via different online social networking resources,
for each activity item in the set, identifying a dynamic relationship between a user of the client-side electronic device and either the subject of the activity item or the publisher of the activity item or both,
receiving a relevance formula from the online server, the relevance formula including at least one time-dependent portion and at least one time-independent portion, the dynamic relationship a factor associated with the time-dependent portion,
for each activity item in the set, calculating a relevance score using the relevance formula,
based on the calculated relevance score, determining a presentation order for each activity item in the set, and
via the client-side electronic device, presenting each activity item in the set to the user in accordance with the determined presentation order.

18. The system according to claim 17, wherein the method further comprises
storing the set,
at a time after the selected time, identifying an updated relevance formula, different from the relevance formula, and
for each activity item in the stored set, calculating a new relevance score using the new relevance formula,
based on the calculated new relevance scores, determining a new presentation order for each activity item in the stored set, and
presenting each activity item in the stored set to the user of the client-side electronic device in accordance with the determined new presentation order.

19. The system according to claim 17, wherein time-independent portion includes a factor based on the subject of the activity item.

20. The system according to claim 17, wherein for each activity item, the dynamic relationship is selected from the group comprising: an online relationship between the publisher and the user; an explicit or inferred interest of the user in the subject; and an amount of online interaction other people have had with the activity item or subject.
